(19) United States
(12) Patent Application Publication
(10) Pub. No.: US 2004/0004721 A1
(43) Pub. Date: Jan. 8, 2004

(54) Two-wave temperature-stablilised optical interferometer and wavelength interleaving device comprising same

(75) Inventors: Herve Lefevre, Paris (FR); Thomas Buret, Versailles (FR); Veronique Dentan, Paris (FR)

Correspondence Address: ARENT FOX KINTNER PLOTKIN & KAHN, 1050 CONNECTICUT AVENUE, N.W., SUITE 400, WASHINGTON, DC, 20036, US

(73) Assignee: NETTEST PHOTONICS, Cedes (FR)

(21) Appl. No.: 10/332,998

(22) PCT Filed: Jul. 30, 2001
(86) PCT No.: PCT/FR01/02491

(30) Foreign Application Priority Data
Jul. 28, 2000 (FR) 00/09967

(51) Int. Cl. G01B 9/02

(52) U.S. Cl. 356/450

(57) ABSTRACT

The invention concerns an optical interferometer (1) with two waves defining two paths of different optical lengths and comprising at least a separator periscope (2, 3, 4) forming a Mach-Zender interferometer. The invention is characterised in that the interferometer (1) comprises, on the short path of the interferometer (1), a compensating plate (6) cut in glass of the same type as the separator periscopes (2, 3, 4) and having as thickness the difference of the glass thickness of the separator periscopes (2, 3, 4) traversed respectively by each of the waves. The invention is applicable to wavelength-multiplexed optical fibre transmission devices.

The development of optical fibre telecommunications has underlined the importance of wavelength multiplexing of numerous signals that are also frequency offset.

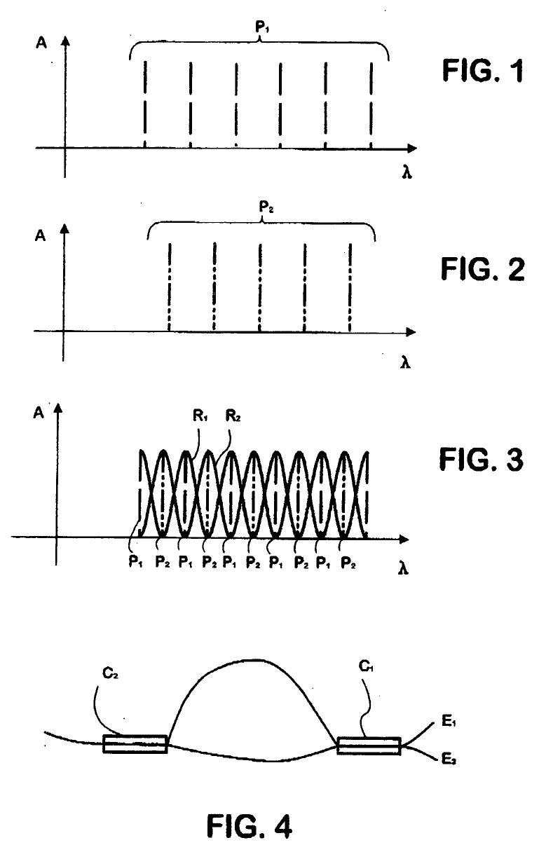

It is in this framework that so-called <<interleavers>> have been used and wherein two combs of multiplexed wavelengths as represented respectively on FIGS. 1 and 2, are addressed to the inputs E1 and E2 of a two-wave interferometer.

The response of the interferometer for each of the inputs E1 and E2 being respectively R1 and R2, suitable adjustment of the interferometer enables multiplexing of both wavelength combs respectively P1 and P2, without any significant energy loss.

The importance of the devices described previously can be easily understood.

More precisely, such a two-wave optical fibre interferometer has conventionally been manufactured by using two couplers, the first input coupler is C1 separating both wavelengths which, after having followed different optical paths, are recombined by the coupler C2.

Adjustment of the optical path difference between both optical paths enables to interleave both wavelength combs respectively P1 and P2 as represented on FIG. 3.

The operation of such device has been described as a multiplexer, interleaving wavelength combs. Obviously, such a device is reversible and may, in reverse direction, as a demultiplexer, separate interleaved wavelength combs.

A defect of this type of Mach-Zehnder interferometer has been noticed inasmuch as the optical path difference between both optical paths is equal to the difference in length of the fibres multiplied by the index of the fibre, and that, consequently, such optical path difference between both paths traversed respectively in either of these fibres, is highly sensitive to temperature further to index variations.

The purpose of the invention is to offer a two-wave optical interferometer as well as an interleaving and dissociation device for a set of wavelength multiplexed signals and that is stable in temperature.

To this end, the invention concerns a two-wave optical interferometer defining two paths of different optical lengths and comprising at least a separator periscope.

According to the invention, it comprises on the short path of the interferometer a compensation plate cut in a glass of the same type as the separator periscopes and having as thickness the difference of the glass thickness of the separator periscopes traversed respectively by each of the waves.

In different embodiments each exhibiting specific advantages and liable to be combined:

it comprises coupling means enabling to use it in an optical fibre system.

it comprises two separator periscopes.

it comprises a separator periscope, a compensation plate and a mirror, the periscope and the compensation plate being traversed symmetrically before and after reflection on the mirror.

it comprises means for orientation of periscope enabling fine-tuning of the interferometer.

it comprises a temperature-stabilised cavity, placed on the long path of the interferometer and whereof the length is equal to the difference in length between both paths.

The invention also concerns an interleaving device of a set of wavelength multiplexed signals.

According to the invention, this device comprises an interferometer as defined above.

The invention concerns moreover a dissociation device of a set of wavelength multiplexed signals. This device also comprises an interferometer as defined above.

FIG. 1 is a representation of a first wavelength comb P1.

FIG. 2 is the representation of a second wavelength comb P2.

FIG. 3 is the representation of these interleaved wavelength combs.

FIG. 4 is a representation of a Mach-Zehnder interferometer of the prior art, made of optical fibres.

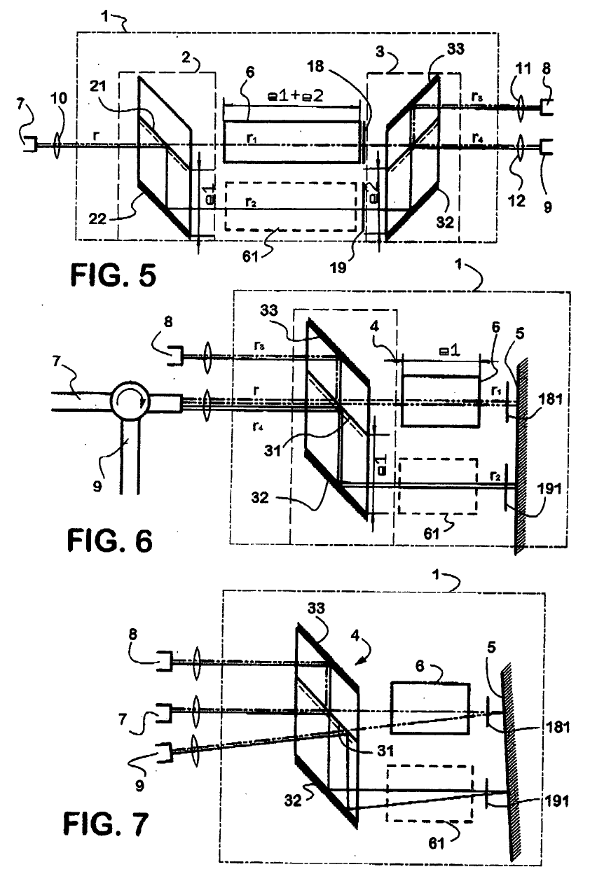

FIG. 5 is a representation of an interleaving device according to the invention, in a first embodiment.

FIG. 6 is a representation of an inter aving device according to the invention, in a second embodiment.

FIG. 7 is a representation of an interleaving device according to the invention, in a third embodiment.

FIG. 5 represents a Mach-Zehnder interferometer 1, realised by the association of two separator periscopes respectively 2 and 3.

The periscope 2 comprises a semi-reflecting plate 21 and a mirror 22.

By construction, this semi-reflecting plate 21 and this mirror 22 are perfectly parallel, which implies that the emerging beams r₁ transmitted directly and r₂ transmitted after two reflections, are themselves perfectly parallel.

Similarly, the separator periscope 3 comprises a semi-reflecting plate 31, a first mirror 32. It also comprises a second mirror 33, parallel both to the mirror 32 and to the semi-reflecting plate 31.

It is known that the association of two separator periscopes of this type positioned symmetrically with respect to one another as represented on FIG. 5, produces a Mach-Zehnder interferometer wherein the optical path difference between the optical paths of both paths is due to the travel through both these separator periscopes 2 and 3 according to the thicknesses e1 and e2 shown on FIG. 5.

The optical path difference thus produced, resulting from the travel of the beams through glass elements, exhibits therefore the shortcoming of being sensitive to temperature variation which may consequently influence such optical path difference.

According to the invention, a compensation plate 6 of thickness e1+e2 is placed on the short optical path of the Mach-Zehnder, i.e. the one which does not go through the glass thicknesses e1 and e2.

Thus, in case of temperature variation, the effects of the variations in thickness and optical index will be similar on each of the paths.

There is thus provided a temperature stabilised Mach-Zehnder interferometer.

The optical path difference between both optical paths is then the result of the difference in length of the paths e1+e2 in the air.

An optical fibre device implementing the interferometer 1 is represented on FIG. 5. An input fibre 7 carrying an interleaved luminous flux associating two wavelength combs P1 and P2 is coupled with the interferometer 1 by means of a collimation lens 10. The end of the optical fibre 7 is placed at the focus of this lens 10.

Similarly, at the output, the emerging beams respectively r₃ and r₄ are coupled with the fibres 8 and 9 by means of the lenses 11 and 12, the end of the fibres being placed at the focusing point of each of these lenses.

Thus, a beam entering through the input fibre 7 comprising interleaved wavelength combs comes out of this device as being separated respectively on the output fibre 8 and on the output fibre 9 providing the optical path difference e1 and e2 between both paths of the Mach-Zehnder have been adapted.

FIG. 6 is a representation of a simplified device fulfilling the same functionalities as that of FIG. 5.

The interferometer 1 implemented in this device comprises a single separator periscope 4 associated with a mirror 5. Beams r₁ and r₂ coming out of this separator periscope are reflected by the mirror 5 and returned to the latter after reflection respectively on the semi-transparent plate 31 and on the mirror 33. This device produces two output beams respectively r₃ and r₄. The beam r₄ being superimposed, but of reverse direction to the input beam r, a circulator 17 enables the separation of these fluxes without any energy loss, the input fibre 7 supplying the beam r and the output fibre 9 receiving the output flux r₄. This situation can be seen obviously in case when the mirror 5 is perpendicular to the emerging beams r₁ and r₂ of the separator periscope 4.

The compensation plate 6 has then a thickness e1 equal to the thickness difference of glass traversed, respectively by each of the paths of the Mach-Zehnder interferometer thus realised.

FIG. 7 represents schematically a third embodiment of the invention, operating according to a principle analogue to that of FIG. 6, wherein to avoid the implementation of a circulator such as the circulator 17, the mirror 5 has been slightly tilted in order to separate spatially the emerging beam r₄ from the incident beam r.

On this FIG. 7, the inclinations of the mirror 5 and of the beams have been represented approximately.

It has been noticed that the beams r₁ and r₂ produced by the separator periscope, are subject before recombination and regardless of the embodiment, a different number of reflections and of transmissions.

Apart from the possible reflection on the mirror 5, the beam r₁ is subject to a total of two transmissions and no reflections, whereas the beam r₂ is subject to two reflections at each travel through a periscope, hence four in total.

This different number of reflections and of transmissions may induce a sensitivity of the interferometer (optical path difference, loss and modulation rate) in the polarisation state of the incident wave.

In a preferred embodiment, this shortcoming can be avoided by placing on each beam r₁, r₂, an anisotropic optical element 18, 19, 181, 191, enabling to obtain a response of the interferometer that is independent from the incident polarisation.

In a first embodiment illustrated on FIG. 5, these anisotropic optical elements can be birefringent neutral plates λ/₂, 18, 19 whereof the neutral axes are 45° with respect to the incidence plane.

In the other embodiments implementing a mirror 5, these elements could be birefringent neutral plates λ/₄ 18, 19, which will be traversed twice by the beam and whereof the neutral axes are 45° with respect to the incidence plane.

In one of the three embodiments described, in order to improve further temperature stabilisation, it is interesting to implement a cavity 61 placed on the long path of the Mach-Zehnder interferometer and containing either a rarefied gas, a temperature stable gas or a temperature-controlled gas.

When the device of the invention is fitted with such a stabilising element 61, the optical path difference between both arms being exclusively due to the propagation of the beam inside this stabilising element, it is exempt of any risks of thermal drift.

It can be understood that, like the devices of the prior art, that of the invention is reversible and may constitute either an interleaving device of a set of wavelength multiplexed signals or a separation device of such a set of signals, according to its direction of use.

Besides, adjusting the inclination of the periscopes with respect to the input and output beams, in the plane of representation of the Figures, enables fine-tuning of the optical path difference between both paths. This adjustment does not affect the parallelism of the beams with respect to one another.

1. A two-wave optical interferometer (1) defining two paths of different optical lengths and comprising at least a separator periscope (2, 3, 4),
characterised in that it comprises, on the short path of the interferometer (1), a compensation plate (6) cut in a glass of the same type as the separator periscopes (2, 3, 4) and having as thickness the glass thickness difference of the separator periscopes (2, 3, 4) traversed respectively by each of the waves.

2. A two-wave optical interferometer according to claim 1, characterised in that it comprises coupling means (10, 11, 12) enabling to use it in an optical fibre system (7, 8, 9).

3. A two-wave optical interferometer according to any of the claims 1 and 2, characterised in that it comprises two separator periscopes (2, 3, 4).

4. A two-wave optical interferometer according to any of the claims 1 and 2, characterised in that it comprises a separator periscope (2, 3, 4), a compensation plate (6) and a mirror (5), the periscope (2, 3, 4) and the compensation plate (6) being traversed symmetrically before and after reflection on the mirror (5).

5. A two-wave optical interferometer according to any of the claims 1 to 4, characterised in that it comprises means for orientation of the periscope (2, 3, 4) enabling fine-tuning of the interferometer (1).

6. A two-wave optical interferometer according to any of the claims 1 to 5, characterised in that it comprises a temperature stabilised cavity (61), placed on the long path of the interferometer (1) and whereof the length is equal to the difference in length between both paths.

7. A two-wave optical interferometer according to any of the claims 1 to 6, characterised in that it comprises an anisotropic optical element (18, 19, 181, 191) placed on each of both optical paths and enabling to obtain a response from the interferometer which is independent from the incident polarisation.

8. An interleaving device of a set of wavelength multiplexed signals, characterised in that it comprises an interferometer (1) according to any of the claims 1 to 7.

9. A dissociation device of a set of wavelength multiplexed signals, characterised in that it comprises an interferometer (1) according to any of the claims 1 to 7.
